(19) United States
(12) Patent Application Publication
(10) Pub. No.: US 2003/0235642 A1
(43) Pub. Date: Dec. 25, 2003

(54) Method of dry fractionation to reduce trans double bonds in vegetable oils

(76) Inventor: Edward T. Huxel, Ft. Worth, TX (US)

Correspondence Address: SPENCER, FANE, BRITT & BROWNE, 1000 WALNUT STREET, SUITE 1400, KANSAS CITY, MO, 64106-2140, US

(21) Appl. No.: 10/387,891

(22) Filed: Mar. 12, 2003

Related U.S. Application Data
(60) Provisional application No. 60/364,419, filed on Mar. 13, 2002.

(51) Int. Cl. C11B 1/00

(52) U.S. Cl. 426/417

(57) ABSTRACT

A method is provided for reducing the quantity of triglycerides containing trans double bonds in vegetable oils.

### CROSS REFERENCE TO RELATED APPLICATION

This application claims benefit of U.S. Provisional Application, serial No. 60/364,419 filed Mar. 13, 2002.

### STATEMENT REGARDING FEDERALLY SPONSORED RESEARCH

Not relevant.

### FIELD OF THE INVENTION

The present invention relates to the manufacture of shortening and oils produced from vegetable oils, in particular, soybean oil having reduced amounts of triglycerides containing trans double bonds . The present invention relates to the preparation of solid flakes of low melting point triglycerides high in concentrates of linoleic and linolenic fatty acid esters. In particular the invention relates to a dry fractionation process which concentrates the higher melt point fraction from the lower melting point fraction, and concentrates the triglycerides with lenolenic fatty acids into the lower melting point fractions. The inventive process is suitable for providing solid and liquid shortenings, and oils having reduced amounts of triglycerides containing trans double bonds and reduced amounts of lenolenic fatty acids in particular.

### BACKGROUND OF THE INVENTION

It has long been known that soybean oil has been hydrogenated to increase the melting points of soybean oil. The degree of hydrogenation results in products of different melting points, and these products are used individually or in combinations, or blended with other oils to create products that are similar to lard, tallow, and butter. Table 3 and Table 4 lists the properties of lard and tallow, respectively. A complete description of soybean oil processing and uses are presented in Handbook of Soy Oil Processing and Utilization, Erickson et. al., American Soybean Association and American Oil Chemist's Society, (1980). Dry fractionation processes are covered in Bailey's Industrial Oil and Fat Products, Vol. 3; Applewhite, Thomas; John Wiley & Son, 1985 and in U.S. Pat. No. 4,161,484 to H. J. Van denBurg, the specification of which is incorporated herein by reference.

It has long been known that hydrogenation of triglycerides produces trans double bonds from dienes and trienes and the double bond locations can be changed giving numerous isomers. In metabolic studies, the oxidation rates for trans monoene fatty acids are slightly slower than for the cis fatty acids. The trans-containing polyunsaturated fats cannot be substituted for the essential fatty acid linoleic acid and may slightly increase the requirements for essential fatty acids. Likewise the trans polyunsaturates are not converted to biologically active prostaglandins. Triglycerides containing only specific fatty acids isomers (trielaidin and linoelaidin) increase plasma cholesterol and triglycerides levels in man. Atherosclerosis has been correlated with serum cholesterol levels, consumption of saturated and polyunsaturated fats, smoking, and several other factors.

In the near future, regulatory agencies are likely to require that the amount of trans fatty acids be included in nutritional labeling requirements for food products. This will have a negative impact on consumer sales of vegetable oils.

In the prior art, dry fractionation processes do not remove the linolenic fraction because of difficulties in removing crystalates from the liquid fractions by centrifuges and filter presses. It will also be appreciated that fractionation can be done with solvents which require solvent recover systems which add to the cost of manufacturing. It is known that the linolenic fraction is the can resulting in flavor reversion and excess oxidation and autoxidation of the double bonds. To produce a stable product the amount of the linolenic fraction must be minimized.

### SUMMARY OF THE INVENTION

The inventive process provides a reduction in the amount of triglycerides having fatty acid ester chains containing multiple trans double bonds in the fatty acid ester chains of vegetable oils. The process is accomplished, generally, by the adding of a solid, preferably flaked, low temperature melting point triglyceride fraction of soybean oil to a precooled amount of liquid, unfractionated vegetable oil. The precooled oil is agitated to prevent crystalization in the oil and to effect distribution of the solid soybean oil which is added to the precooled oil. The mixture of precooled oil and solid soybean oil is allowed to then stand and equilibrate whereupon the solid soybean oil melts within the precooled oil and crystalization is initiated in the precooled oil. As the higher temperature melting point components of the precooled oil solidify the lower temperature melting point components of the precooled oil will accumulate and coalesce with the, now liquid, lower temperature melting point soybean fraction which was added into the precooled oil. The result is a semi-solid mass much like cottage cheese. After sufficient solidification of the precooled oil into the semi-solid mass the structure of the mass is then disrupted to allow the still liquid low temperature melting point triglycerides having trans double bonds to escape from the solid mass whereupon they can be drained away from the now solid and semi-solid higher temperature melting point components of the precooled oil.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a side view of the equilibration tank used to hold the precooled oil and into which the low temperature melting point soybean solid is added;

FIG. 2 is a top view of the equilibration tank of FIG. 1 having a feed system also shown for adding the solid;

FIG. 3 is a schematic diagram of a cross-section the mixed precooled liquid oil and the flaked low temperature melting point soybean solid;

FIG. 4 is a schematic diagram of a cross-section the mixed precooled liquid oil and the low temperature melting point soybean after the melting of the low temperature melting point soybean solid mixed into the precooled oil and the solidification of the precooled oil;

FIG. 5 is a flow chart of the manufacturing process of edible soybean oil products; and

FIG. 6 is a flow chart showing the present inventive process within the overall process of product manufacturing from crude soybean oil.

### DESCRIPTION OF THE PREFERRED EMBODIMENT

As required, detailed embodiments of the present inventions are disclosed herein, however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention provides a process for reducing the amount of triglycerides having trans double bonds in vegetable oils by using the following processing steps. A fraction containing a high percentage of low temperature melting point triglycerides from soybean oil is flaked. In Table 2 melting points are given for different triglycerides. The low temperature melting point triglyceride fraction is made up of triglycerides with the unsaturation or double bond profiles of 320, 321, 322, 222, 221, and 220 as given in Table 1. For example the double bond profile of “320” means that a first fatty acid chain of a particular triglyceride has 3 double bonds and that the middle fatty acid chain of a particular triglyceride has 2 double bonds and the final fatty acid chain of a particular triglyceride has no double bonds and is saturated.

The soybean oil fraction is made solid, preferably by flaking on flat plate flaker cooled to a temperature of −25° C. The plate can be cooled with liquid nitrogen, liquid carbon dioxide, or ammonia. The differential temperature between the plate and desired finished product should be 25° F.

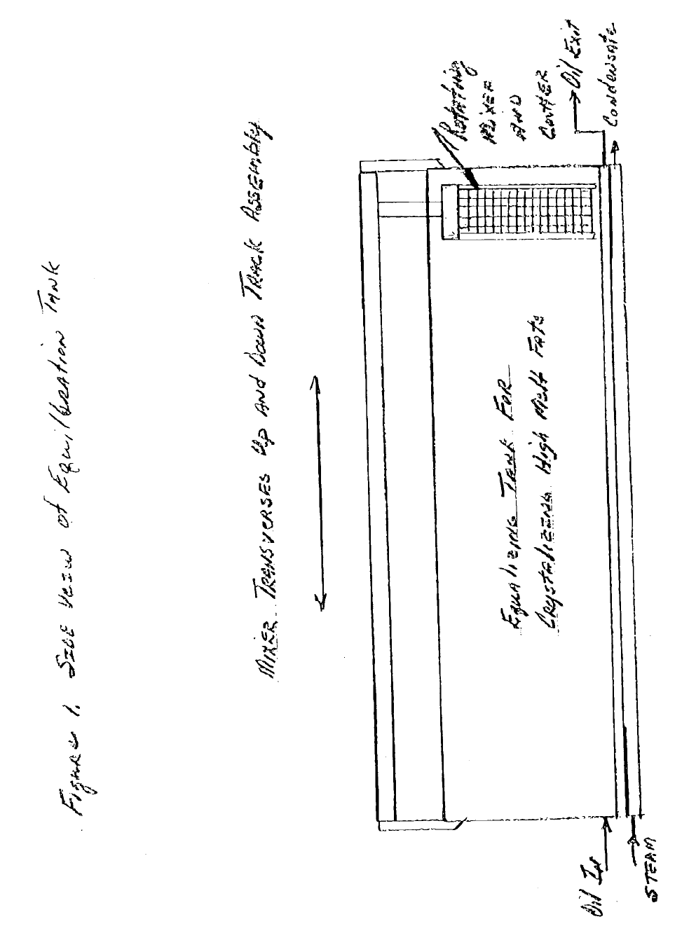

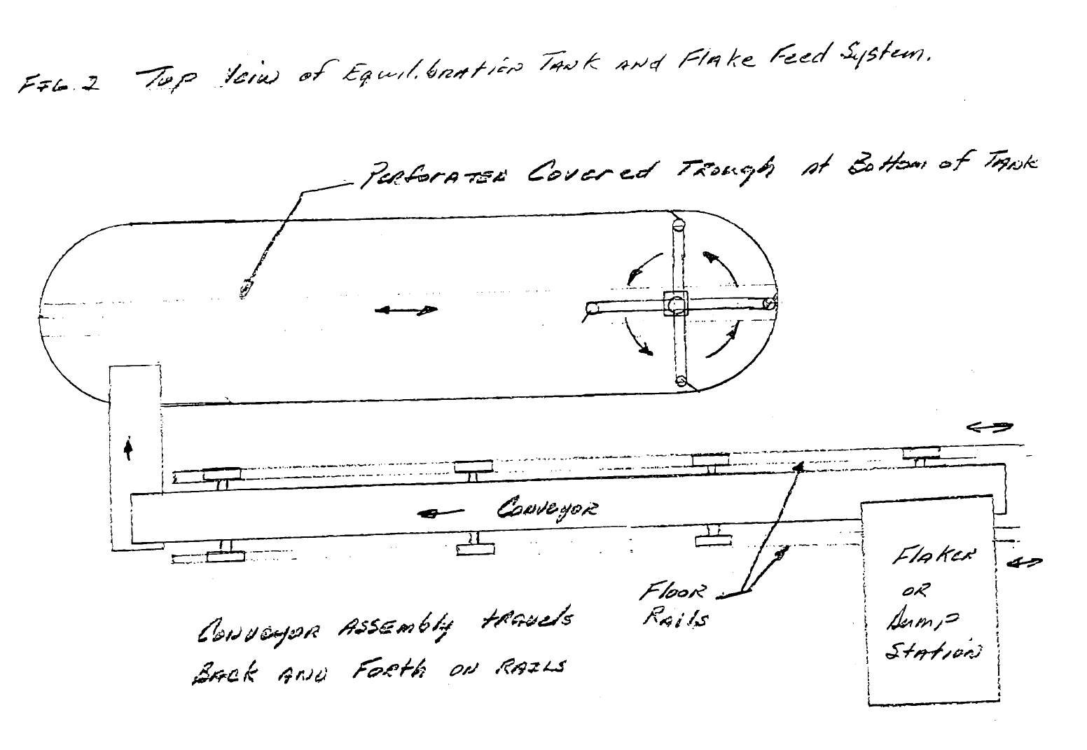

Pre-cooled unfractionated vegetable oil, in particular, soybean oil is added to an open tank. The type of tank used is shown in FIGS. 1 and 2. The tank is very similar to a cottage cheese fermentation tank and whey/curd separation system. The tank has a rotating mixer/cutter which transverses the entire length of tank. A perforated bottom plate is provided in the tank to allow drainage of residual liquids at the end of the process.

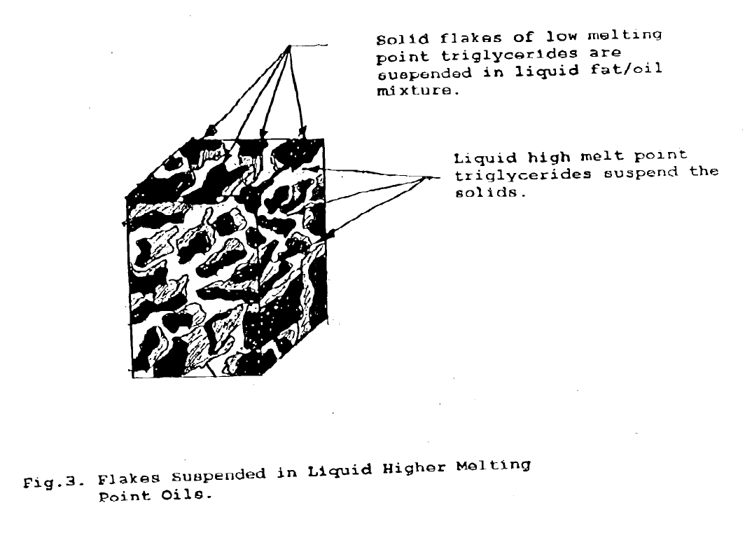

The low temperature melting point soybean flake is added to the tank by means of a conveyor system shown in FIG. 1. The amount of flake added on the weight basis is depended on the degree of separation needed. Normally, 30% to 50% by weight of the low temperature melting point flake is added to the pre-cooled unfractionated vegetable oil. Once the flake is added, the agitator can move up and down the plate to evenly disperse the flake evenly in the unfractionated oil as shown in FIG. 3.

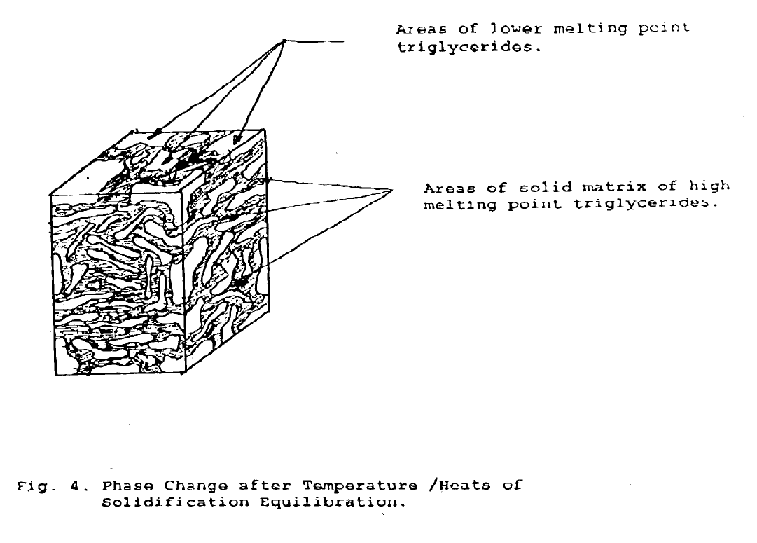

After sufficient mixing, the oil containing the solid flake is allowed to stand without agitation. This step is the equilibration phase. Since the pre-cooled unfractionated oil has a temperature of 5° C. to 15° C., the flaked solid low melt point triglycerides melt into the precooled liquid. Melting is first caused by the flake absorbing the sensible heat and second by absorbing the heat of fusion or crystalization of the precooled liquid which itself is beginning to crystalize. As shown in FIG. 3 the flakes (dark hatched area) are represented by cutting them across their planes and the shaded are sides of the flakes extending into their respective planes. The undarkened areas or spaces are filled liquid unfractionated oil in the initial equilibration phase. Over time and as the solid flakes melt, voids of liquid low melting point triglycerides are formed as represented by white areas of the three dimensional cross section cube shown in FIG. 4. During the same time, the unfractionated liquid phase slowly solidifies with the high melting point triglycerides first forming crystals. As these triglycerides hardened and give up their sensible heat and the heat of fusion they form a solid, irregular matrix around the now liquid low melting fraction. As shown in FIG. 4 the dark area represents the matrix of solidified high melt point oil. During the equilibration phase the low melting point oils in the unfractionated phase move into the low melt point fraction in a manner similar to freeze concentration processes. The objective is to increase the volume of the low melt point oils by 25% and decrease the volume of high melt point by an equal 25%. The final mass will have a temperature of approximately 0° C. temperature depending upon the degree of heat loss to the surrounding atmosphere.

Once the higher melting point triglycerides have sufficiently solidified into a matrix, the electrically heated resistive, thin wires mounted on the agitator are activated and heated. The agitator slowly rotates and transverses up and down the tank cutting the solid matrix, releasing the entrapped liquid fraction. This operation of the process is similar to the making of cottage cheese in which the protein coagulates creating voids of entrapped liquid whey. As the curd is cut to allow the liquid whey to escape.

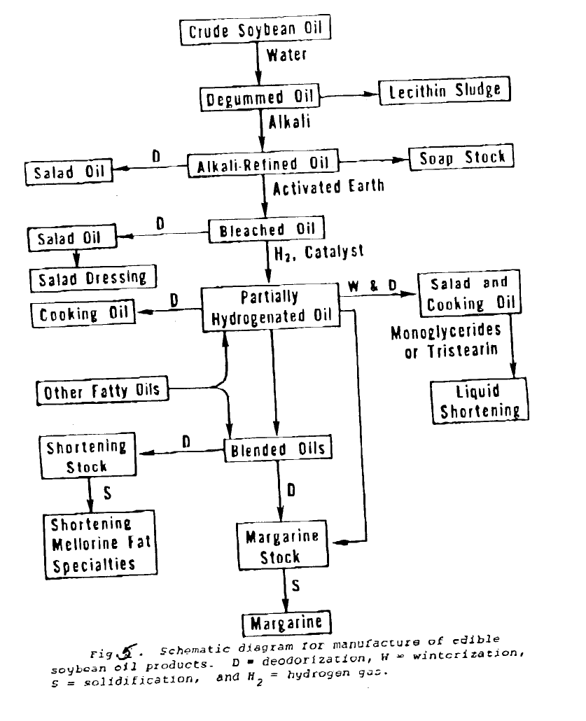

The liquid fraction is allowed to drain from solid matrix. The liquid fraction drains through a perforated plate covered trough in the bottom of the tank and is pumped to a separate holding tank. Twenty-five percent (25%) of this liquid is pumped to a different tank for further processing as shown in FIG. 5. The original volume of oil is flaked again.

Once sufficient, low melt point oil has been removed the remaining solid matrix is melted by steam jackets in the bottom of the tank. Once melted the oil is pumped to a tank for further processing. This fraction will contain very low levels of linolenic fatty acid containing triglycerides. This process may be repeated as needed to reduce the quantity of trans double bond triglycerides in the cooled liquid oil as is required to provide the desired reduction in trans double bond triglycerides.

The dry fractionation process is one step in an overall system to produce trans free shortening and oil products. A typical system for producing soybean products is shown in FIG. 5.

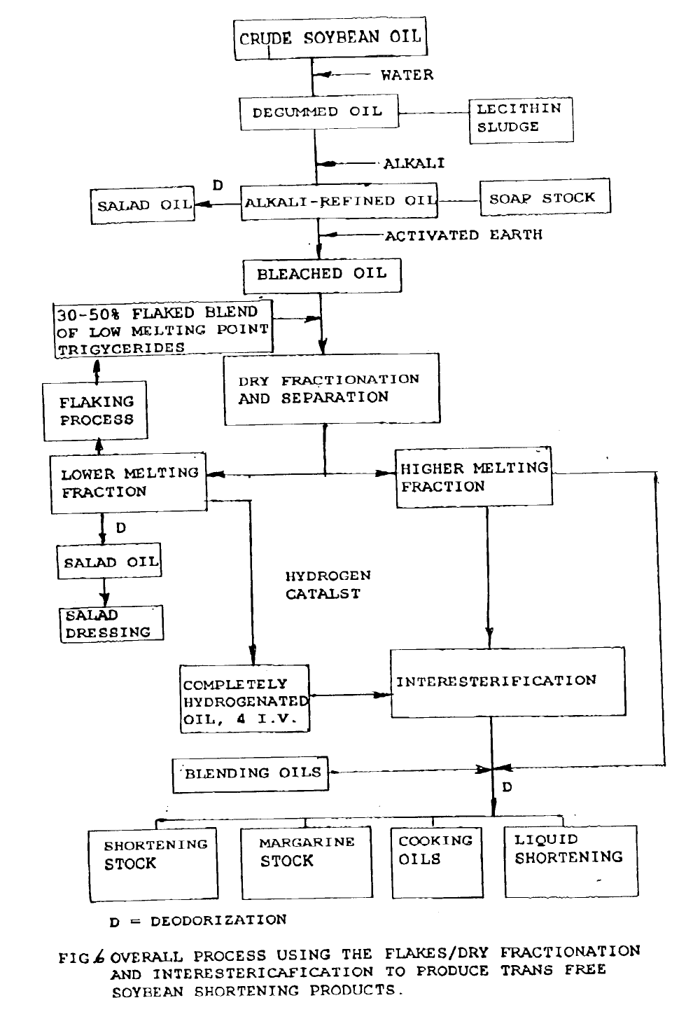

In particular, this invention relates to the incorporation of the above dry fractionation process into a system as shown in FIG. 6. The overall system uses prior art of hydrogenation and interesterification to produce trans free products. Only a small percentage of the lower melting fraction is hydrogenated and is completely hydrogenated. The 4 I.V. hydrogenated product is essentially free of trans double bond containing fatty acids. The hydrogenation oil and the higher melting point fraction are blended and interesterified. In this process the fatty acids rearranged on the triglyceride molecule giving fat fractions unique properties. The objective is to increase the levels of SSS, SSM, SMM, SSD, MSD, and SSD in the products. By controlling the amount of completely hydrogenated fat added to the precooled oil, the following parameters of the end product can be controlled—degree of saturation, SFI profile and melting point.

TABLE 1
Soybean Oil Composition

| | | Soybean Oil | |
|---|---|---|---|
| Fatty Acid Profile | | Triglycerides | Triglycerides |
| Saturated | | | |
| Palmitic | 10.7% | SSS | .1% |
| Stearic | 3.9% | SUS | 5.2% |
| Arachidic | .2% | USS | .4% |
| Other | .3% | USU | .7% |
| | 15.0% | UUS | 35.0% |
| | | UUU | 58.4% |
| Monenes | | | |
| Palmitoleic | .3% | | |
| Oleic | 22.8% | S = Saturated | |
| Dienes | | U = Unsaturated | |
| Linoleic | 50.8% | | |
| Trienes | | | |
| Linolenic | 6.8% | | |

Triglycerides - distribution by mole percent
(glyceride chains designated by the number of double bonds in each acid)

| | | |
|---|---|---|
| Triglyceride | % | |
| 110 | 5 | 0 = saturated |
| 221 | 16 | 1 = monoene |
| 222 | 15 | 2 = diene |
| 220 | 13 | 3 = triene |
| 210 | 12 | |
| 211 | 8 | |
| 322 | 7 | |
| 321 | 5 | |
| 320 | 4 | |

TABLE 2
Melting Points of Triglycerides Present in Soybean

| | Melting Point (° C.) B | |
|---|---|---|
| Triglycerides | Crystals | Mole Fraction |
| Tristearin | 73.0 | |
| 18:0-16:0-18:0 | 68.0 | |
| 16:0-18:0-16:0 | 68.0 | 2% |
| 18:0-16:0-16:0 | 62.5 | |
| Tripalmitin | 65.5 | |
| 18:0-18:1-18:0 | 41.6 | |
| 16:0-18:1-16:0 | 35.2 | |
| 18:0-18:1-18:1 | 23.5 | |
| | | 5% |
| 16:0-18:1-18:1 | 19.0 | |
| | | 13% |
| Triolein | 5.5 | |
| | | 49% |
| Trilenolin | −13.1 | 15% |
| | | 16% |
| Trilenolenin | | −24.2 |

TABLE 3
Properties of Lard

Fatty Acid Profile

| | |
|---|---|
| Saturated | 24.0% |
| Palmitic | 13.0% |
| Stearic | 37.0% |
| Monoenes | 2.8% |
| Palmitoleic | 43.5% |
| Oleic | 46.3% |
| Dienes | 11.2% |
| Lenoleic | |
| Trienes | 1.3% |
| Lenolenic | |

Triglycerides Compositions

| | | Accumulated | |
|---|---|---|---|
| Triglycerides | Mole Fraction | Mole Fraction | |
| SSS | 2.4 | | |
| SSM | 24.1 | 26.5 | |
| SMM | 3.5 | 30.5 | |
| MSM | 29.8 | 59.8 | M = Monoenic acids |
| MMM | 8.5 | 68.3 | D = Dienoic acids |
| SSD | 4.5 | 72.8 | S = Saturated acids |
| MSD | 14.5 | 87.3 | |
| MMD | 4.3 | 91.6 | |
| MDM | 2.3 | 93.9 | |
| SDD | 2.4 | 96.3 | |
| MDD | 3.2 | 99.5 | |

TABLE 4
Properties of Tallow

| Fatty Acid Profiles | | |
|---|---|---|
| Saturates | | |
| Myristic | 6.3% | |
| Palmitic | 27.4% | |
| Stearic | 14.1% | |
| Monoenes | | |
| Oleic | 49.6% | |
| Dienes | | |
| Lenoloic | 2.5% | |
| Triglycerides Compositions | | |
| Triglycerides | Mole Fractions | |
| SSS | 14.0 | S = Saturated |
| SUS | 28.8 | U = Unsaturated |
| SSU | 21.9 | |
| SUU | 24.7 | |
| UUU | 10.7 | |

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive dry fractionation method is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A method of making vegetable oils having low quantities of oil components containing trans double bonds comprising:
providing a soybean oil solid comprising a high percentage of low temperature melting point triglycerides,
cooling a liquid, unfractionated vegetable oil to a temperature of between 5 to 15 degrees centigrade to provide a cooled oil,
agitating said cooled oil,
adding said soybean oil solid to said cooled oil during said agitating to provide a soybean solid and cooled oil mixture,
letting said soybean solid and cooled oil mixture stand,
allowing said soybean solid to melt to form pools of melted, low temperature melting point triglycerides within said cooled oil,
allowing said cooled oil to slowly solidify to form a semi-solid mass comprising solids and semi-solids of higher temperature melting point fractions of said cooled oil and liquid lower temperature melting point fractions of said cooled oil,
allowing said liquid lower temperature melting point fractions of said cooled oil to combine with said pools of melted, low temperature melting point triglycerides, and
(claim 1, continued)
disrupting said mass to allow said combined liquid portions of lower temperature melting point cooled oil portions and said drops to flow away from said mass.

2. The method as claimed in claim 1 wherein said soybean oil solid is comprised of triglycerides having multiple double bonds in at least two adjacent fatty acid ester chains.

3. The method as claimed in claim 1 wherein said soybean solid and cooled oil mixture comprises 30 percent to 50 percent by weight of soybean solid.

4. The method as claimed in claim 1 wherein said soybean solid is a linoleic acid ester triglyceride.

5. The method as claimed in claim 1 wherein said soybean solid is a linolenic acid ester triglyceride.

6. The method as claimed in claim 1 wherein said soybean solid is substantially comprised of linoleic and linolenic fatty acid ester triglycerides.
